(19) United States
(12) Patent Application Publication
(10) Pub. No.: US 2016/0020007 A1
(43) Pub. Date: Jan. 21, 2016

(54) NON-ORIENTED ELECTRICAL STEEL SHEET HAVING EXCELLENT HIGH-FREQUENCY IRON LOSS PROPERTY

(71) Applicant: JFE STEEL CORPORATION, Tokyo (JP)

(72) Inventors: Yoshihiko Oda, Tokyo (JP); Hiroaki Toda, Tokyo (JP); Shinji Koseki, Tokyo (JP); Tatsuhiko Hiratani, Tokyo (JP); Tadashi Nakanishi, Tokyo (JP)

(21) Appl. No.: 14/775,925

(22) PCT Filed: Mar. 12, 2014
(86) PCT No.: PCT/JP2014/056426

§ 371 Date: Sep. 14, 2015

(30) Foreign Application Priority Data
Mar. 15, 2013 (JP) 2013-053307

(51) Int. Cl. H01F 1/147; C22C 38/14; C22C 38/00; C22C 38/06; C22C 38/04; C22C 38/02; C22C 38/60; C22C 38/12

(52) U.S. Cl. CPC H01F 1/14775; C22C 38/60; C22C 38/14; C22C 38/12; C22C 38/06; C22C 38/04; C22C 38/02; C22C 38/008; C22C 38/004; C22C 38/002; C22C 38/001

(57) ABSTRACT

A non-oriented electrical steel sheet has a chemical composition including C: not more than 0.005 mass %, Si: 1.5-4 mass %, Mn: 1-5 mass %, P: not more than 0.1 mass %, S: not more than 0.005 mass %, Al: not more than 3 mass %, N: not more than 0.005 mass %, Pb: not more than 0.001 mass % and the remainder being Fe and inevitable impurities or a chemical composition including C: not more than 0.005 mass %, Si: 1.5-4 mass %, Mn: 1-5 mass %, P: not more than 0.1 mass %, S: not more than 0.005 mass %, Al: not more than 3 mass %, N: not more than 0.005 mass %, Pb: not more than 0.0020 mass % and further one or two of Ca: 0.0005-0.007 mass % and Mg: 0.0002-0.005 mass %, and has a stable and excellent high-frequency iron loss property even when Mn content is high.

### TECHNICAL FIELD

This disclosure relates to a non-oriented electrical steel sheet having an excellent high-frequency iron loss property.

### BACKGROUND

A motor for hybrid automobiles and electric automobiles is driven at a high-frequency area of 400-2 k Hz from a viewpoint of miniaturization and high efficiency. A non-oriented electrical steel sheet used in a core material for such a high-frequency motor is desired to be low in the iron loss at such high frequency.

To reduce iron loss at the high frequency, it is effective to decrease sheet thickness and increase specific resistance. However, the method of decreasing the sheet thickness has a problem of lowering productivity because not only handling of the material is difficult due to the decrease in its rigidity, but also the punching number or stacking number is increased. On the contrary, the method of increasing the specific resistance has no demerits as mentioned above, so that it is said to be desirable as a method of decreasing a high-frequency iron loss.

The addition of Si is effective in increasing specific resistance. However, Si is an element having a large solid-solution strengthening ability, so that there is a problem that the material is hardened with the increase in Si addition amount to deteriorate rolling properties. As a countermeasure to solve this problem, there is a method of adding Mn instead of Si. Since Mn is small in its solid-solution strengthening ability compared to Si, high-frequency iron loss can be reduced while suppressing the decrease in the productivity.

For example, as a technique utilizing the above addition effect of Mn, JP 2002-047542 A discloses a non-oriented electrical steel sheet containing Si: 0.5-2.5 mass %, Mn: 1.0-3.5 mass % and Al: 1.0-3.0 mass %. Also, JP 2002-030397 A discloses a non-oriented electrical steel sheet containing Si: not more than 3.0 mass %, Mn: 1.0-4.0 mass % and Al: 1.0-3.0 mass %.

However, the techniques disclosed in JP 2002-047542 A and JP 2002-030397 A have a problem that hysteresis loss is increased with the increase in Mn addition and, hence, the desired effect of reducing the iron loss may not be obtained.

It could therefore be helpful to provide a non-oriented electrical steel sheet having an excellent high-frequency iron loss property stably even if a great amount of Mn is included.

### SUMMARY

We studied impurity ingredients included in the steel sheet to address the above issues. As a result, we found that deterioration of high-frequency iron loss property of a high Mn-added steel is dependent on the presence of Pb included as an impurity and, hence, high-frequency iron loss can be stably reduced by suppressing the Pb content even with a high Mn content.

We thus provide a non-oriented electrical steel sheet having a chemical composition comprising C: not more than 0.005 mass %, Si: 1.5-4 mass %, Mn: 1-5 mass %, P: not more than 0.1 mass %, S: not more than 0.005 mass %, Al: not more than 3 mass %, N: not more than 0.005 mass %, Pb: not more than 0.0010 mass % and the remainder being Fe and inevitable impurities.

The non-oriented electrical steel sheet is characterized by containing one or two of Ca: 0.0005-0.007 mass % and Mg: 0.0002-0.005 mass % in addition to the above chemical composition.

Also, the non-oriented electrical steel sheet is characterized by containing one or two of Sb: 0.0005-0.05 mass % and Sn: 0.0005-0.05 mass % in addition to the above chemical composition.

Furthermore, the non-oriented electrical steel sheet is characterized by containing Mo: 0.0005-0.0030 mass % in addition to the above chemical composition.

In addition, the non-oriented electrical steel sheet is characterized by containing Ti: not more than 0.002 mass %.

It is thus possible to stably produce a non-oriented electrical steel sheet having an excellent high-frequency iron loss property by suppressing the content of Pb included as an impurity even if the addition amount of Mn is high.

### BRIEF DESCRIPTION OF THE DRAWINGS

FIG. 1 is a graph showing the influence of Pb content on the relationship between Mn content and high-frequency iron loss W_{10/400}.

FIG. 2 is a graph showing the relationship between Pb content and high-frequency iron loss W_{10/400}.

### DETAILED DESCRIPTION

An experiment will be first described below.

A steel containing C: 0.0012 mass %, Si: 3.3 mass %, P: 0.01 mass %, S: 0.0005 mass %, Al: 1.3 mass % and N: 0.0021 mass % and added with Mn changing within a range of 0.1-5.5 mass % is melted in a laboratory and shaped into a steel ingot, which is hot rolled, subjected to a hot band annealing at 1000° C. in an atmosphere of 100 vol % N₂ for 30 seconds, cold rolled to obtain a cold rolled sheet having a sheet thickness of 0.30 mm and subjected to finishing annealing at 1000° C. in an atmosphere of 20 vol % H₂-80 vol % N₂ for 30 seconds.

From the thus obtained cold rolled and annealed sheet are cut out specimens for an Epstein test with width of 30 mm and length of 280 mm in the rolling direction and a direction perpendicular to the rolling direction and an iron loss W_{10/400} thereof is measured according to JIS C2550.

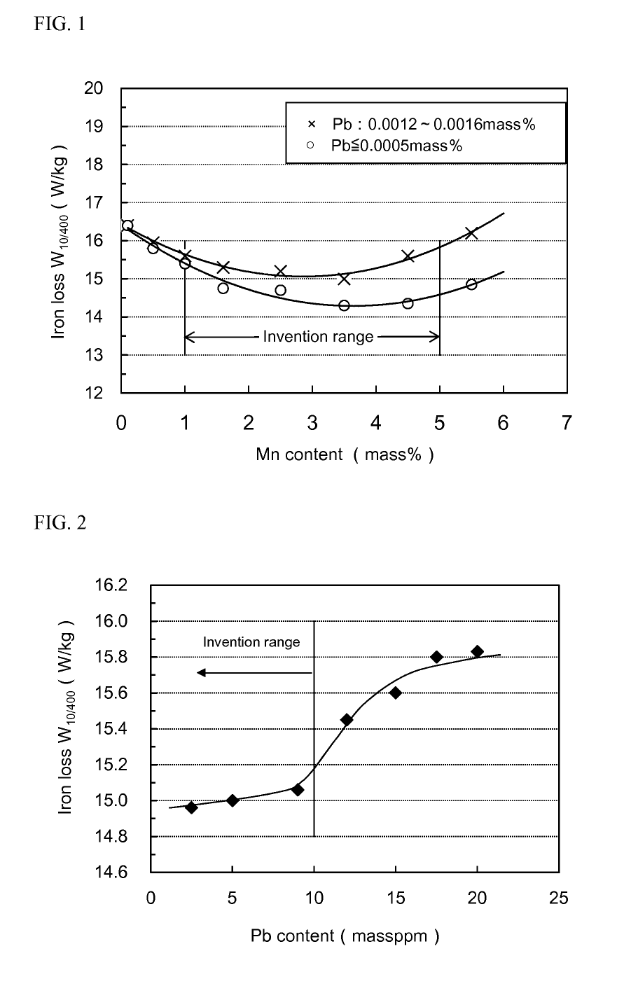

In FIG. 1, symbol×shows the experimental results as the relationship between the Mn addition amount and iron loss W_{10/400.} As seen from these results, when the Mn content is less than 1 mass %, the iron loss decreases with the increase in Mn addition amount, while reduction of the iron loss becomes gentle in an amount of not less than 1 mass %, but when it exceeds 4 mass %, the iron loss rather increases. To examine this cause, when the steel sheet containing 2 mass % of Mn is observed by TEM, granular Pb compound is found in grain boundaries. As such a steel sheet is further analyzed, Pb is included in an amount of 0.0012-0.0016 mass % as an impurity.

To further examine the influence of Pb on the magnetic properties, the iron loss W_{10/400} is measured by melting a steel based on a high-purity steel containing C: 0.0013 mass %, Si: 3.1 mass %, Al: 1.1 mass %, P: 0.01 mass %, S: 0.0005 mass %, N: 0.0025 mass % and Pb: 0.0005 mass % and added with Mn changing within a range of 0.1-5.5 mass % in a laboratory and then shaping into a cold rolled and annealed sheet in the same manner as in the above experiment.

The thus obtained experimental results are shown by symbol ∘ in FIG. 1. As seen from these results, iron loss is reduced in the cold rolled and annealed sheet made from the high-purity steel having a reduced Pb content as the addition amount of Mn is increased as compared to the steel sheet shown by symbol ×. Also, when the steel sheet containing 2 mass % of Mn is observed by TEM, granular Pb compound is not found in the grain boundaries. From this result, we believe that the increase in iron loss associated with the increase in Mn addition amount in the steel sheet shown by symbol × is due to the increase in hysteresis loss by precipitation of fine Pb.

In the steel sheet containing Mn of less than 1 mass %, the effect of improving the iron loss by reduction of Pb is recognized, but the ratio thereof is small, which is not elucidated sufficiently. In the steels having a higher Mn content, we believe that since the driving force of grain growth is decreased by solute drag of Mn, grain growth is liable to be largely influenced by the slight amount of Pb.

Pb is generally an impurity incorporated from scrap. Recently, since the use rate of scrap is increased, not only the amount incorporated but also the dispersion thereof is increased. Such an increase in Pb content becomes not a significant problem in the electrical steel sheets having a low Mn content. However, steels having a high Mn content are believed to be largely influenced by the slight amount of Pb since the grain growth is decreased by solute drag of Mn.

To examine the influence of Pb content on iron loss, the iron loss W_{10/400} is measured by melting a steel based on a steel containing C: 0.0020 mass %, Si: 3.15 mass %, Mn: 1.8 mass %, Al: 1.2 mass %, P: 0.01 mass %, S: 0.0006 mass % and N: 0.0017 mass % and added with Pb changing within a range of tr.−0.0060 mass % in a laboratory and then shaping into a cold rolled and annealed sheet of 0.30 mm in thickness in the same manner as in the above experiment.

The experimental results are shown in FIG. 2 as a relation between Pb addition amount and iron loss W_{10/400.} As seen from this figure, iron loss is highly decreased when the Pb content is not more than 0.0010 mass % (not more than 10 mass ppm). This is based on the fact that the grain growth is improved by decreasing the Pb content. From this result, it can be seen that it is necessary to decrease the Pb content to not more than 0.0010 mass % to suppress the bad influence of Pb on grain growth.

The chemical composition of the non-oriented electrical steel sheet will be described below.

### C: Not More Than 0.005 Mass %

C is an element forming a carbide with Mn. When the content exceeds 0.005 mass %, the amount of Mn-based carbide is increased to obstruct the grain growth, so that the upper limit is 0.005 mass %. Preferably, it is not more than 0.002 mass %.

### Si: 1.5-4 Mass %

Si is an element effective in enhancing specific resistance of steel to reduce iron loss, so that it is added in an amount of not less than 1.5 mass %. When it is added in an amount exceeding 4 mass %, the magnetic flux density is decreased, so that the upper limit is 4 mass %. Preferably, the lower limit of Si is 2 mass %, while the upper limit thereof is 3.5 mass %.

### Mn: 1-5 Mass %

Mn is an ingredient effective in increasing specific resistance of steel to reduce iron loss without largely damaging workability and is important, so that it is added in an amount of not less than 1 mass %. An addition of not less than 1.6 mass % is preferable to more enhance the effect of reducing iron loss. When it is added in an amount exceeding 5 mass %, the magnetic flux density is decreased, so that the upper limit is 5 mass %. Preferably, the lower limit of Mn is 1.6 mass %, while the upper limit thereof is 3 mass %.

### P: Not More Than 0.1 Mass %

P is an element having a large solid-solution strengthening ability. When it is included in an amount exceeding 0.1 mass %, the steel sheet is significantly hardened to lower productivity, so that it is restricted to not more than 0.1 mass %. Preferably, it is not more than 0.05 mass %.

### S: Not More Than 0.005 Mass %

S is an inevitable impurity. When it is included in an amount exceeding 0.005 mass %, grain growth is obstructed by precipitation of MnS to increase iron loss, so that the upper limit is 0.005 mass %. Preferably, it is not more than 0.001 mass %.

Al: Not More Than 3 Mass %

Al is an element effective in enhancing specific resistance of steel to reduce iron loss similar to Si. When it is added in an amount exceeding 3 mass %, the magnetic flux density is decreased, so that the upper limit is 3 mass %. Preferably, it is not more than 2 mass %. However, when the Al content is less than 0.1 mass %, fine AlN is precipitated to obstruct grain growth and increase iron loss, so that the lower limit is preferably 0.1 mass %.

### N: Not More Than 0.005 Mass %

N is an inevitable impurity penetrated from air into steel. When the content is large, the grain growth is obstructed by precipitation of AlN to increase iron loss, so that the upper limit is restricted to 0.005 mass %. Preferably, it is not more than 0.003 mass %.

### Pb: Not More Than 0.0010 Mass %

Pb is an important element to be controlled because it badly affects high-frequency iron loss properties. As seen from FIG. 2, when the Pb content exceeds 0.0010 mass %, iron loss is violently increased. Therefore, Pb is restricted to not more than 0.0010 mass %. Preferably, it is not more than 0.0005 mass %.

The non-oriented electrical steel sheet preferably contains one or two of Ca and Mg in addition to the above chemical composition.

### Ca: 0.0005-0.007 Mass %

Ca is an element effective in forming a sulfide, precipitating and coarsening together with Pb to suppress harmful action of Pb and reduce the iron loss. It is preferably added in an amount of not less than 0.0005 mass % to obtain such an effect. When it is added in an amount exceeding 0.007 mass %, the amount of CaS precipitated becomes too large and iron loss is rather increased, so that the upper limit is preferably 0.007 mass %. More preferably, the lower limit of Ca is 0.0010 mass %, while the upper limit thereof is 0.0040 mass %.

Mg: 0.0002-0.005 mass %

Mg is an element effective in forming an oxide, precipitating and coarsening together with Pb to suppress harmful action of Pb and reduce the iron loss. It is preferably added in an amount of not less than 0.0002 mass % to obtain such an effect. When it is added in an amount exceeding 0.005 mass %, the addition itself is difficult and also the increase in cost is unnecessarily caused, so that the upper limit is preferably 0.005 mass %. More preferably, the lower limit of Mg is 0.0005 mass %, while the upper limit thereof is 0.003 mass %.

Moreover, when Ca and/or Mg are added, an acceptable Pb content can be enlarged to 0.0020 mass % by the effect of suppressing the harmful action of Pb.

Furthermore, the non-oriented electrical steel sheet preferably contains the following ingredients in addition to the above chemical composition.

### Sb: 0.0005-0.05 Mass %, Sn: 0.0005-0.05 Mass %

Sb and Sn have an effect in improving the texture to increase magnetic flux density, so that they can be added in an amount of not less than 0.0005 mass % alone or in admixture. More preferably, each of them is not less than 0.01 mass %. However, when each of them is added in an amount exceeding 0.05 mass %, embrittlement of the steel sheet is caused, so that the upper limit of each of them is preferably 0.05 mass %.

### Mo: 0.0005-0.0030 Mass %

Mo has an effect of coarsening the resulting carbide to reduce the iron loss, so that it is preferably added in an amount of not less than 0.0005 mass %. However, when it is added in an amount exceeding 0.0030 mass %, the amount of the carbide becomes too large and, hence, iron loss is rather increased, so that the upper limit is preferably 0.0030 mass %. More preferably, the lower limit of Mo is 0.0010 mass %, while the upper limit thereof is 0.0020 mass %.

### Ti: Not More Than 0.002 Mass %

Ti is an element forming a carbonitride. When the content is large, the amount of the carbonitride precipitated becomes too large, whereby grain growth is obstructed to increase iron loss. Therefore, Ti is preferably limited to not more than 0.002 mass %. More preferably, it is not more than 0.0010 mass %.

Moreover, the remainder other than the aforementioned ingredients in the non-oriented electrical steel sheet is Fe and inevitable impurities. However, other elements may be included within a range of not damaging the desired effect.

Next, there will be described the production method of the non-oriented electrical steel sheet.

In the production of the non-oriented electrical steel sheet, conditions other than the aforementioned chemical composition of the steel sheet are not particularly limited, so that the steel sheet can be produced under the same conditions as in the usual non-oriented electrical steel sheets as long as the chemical composition is within our range. For example, it can be produced by melting a steel having a chemical composition in a converter, a degassing device or the like, forming a raw steel material (slab) through continuous casting, ingot making-blooming or the like, hot rolling, hot band annealing as requested, subjecting a single cold rolling or two or more cold rollings sandwiching an intermediate annealing therebetween to a given sheet thickness and subjecting to finishing annealing.

### EXAMPLE

A steel having a chemical composition shown in Table 1 obtained by degassing a molten steel blown in a converter is melted and continuously cast to obtain a slab. The slab is heated at 1100° C. for 1 hour, subjected to a hot rolling in which an end temperature of finish rolling is 800° C., wound in the form of a coil at a temperature of 610° C. to obtain a hot rolled sheet of 1.8 mm in thickness. Then, the hot rolled sheet is subjected to a hot band annealing in an atmosphere of 100 vol % N₂ at 1000° C. for 30 seconds, cold rolled to obtain a cold rolled sheet of 0.35 mm in thickness, which is subjected to finishing annealing in an atmosphere of 20 vol % H₂-80 vol % N₂ at 1000° C. for 10 seconds to obtain a cold rolled and annealed sheet.

From the thus obtained cold rolled and annealed sheet are cut out specimens for an Epstein test with a width of 30 mm and a length of 280 mm in the rolling direction and in a direction perpendicular to the rolling direction to measure iron loss W_{10/400} and magnetic flux density B₅₀ according to JIS C2550. The results are also shown in Table 1.

TABLE 1

| | Chemical component (mass %) | | | | | | | | | |
|---|---|---|---|---|---|---|---|---|---|---|
| No. | C | Si | Mn | P | S | Al | N | Pb | Ca | Mg |
| 1 | 0.0011 | 3.10 | 1.60 | 0.010 | 0.0004 | 1.21 | 0.0012 | 0.0002 | tr. | tr. |
| 2 | 0.0014 | 3.10 | 1.60 | 0.012 | 0.0004 | 1.21 | 0.0016 | 0.0005 | tr. | tr. |
| 3 | 0.0021 | 3.12 | 1.60 | 0.011 | 0.0004 | 1.21 | 0.0015 | 0.0005 | tr. | tr. |
| 4 | 0.0016 | 3.11 | 1.60 | 0.012 | 0.0004 | 1.21 | 0.0017 | 0.0015 | tr. | tr. |
| 5 | 0.0011 | 3.10 | 1.60 | 0.012 | 0.0004 | 1.21 | 0.0018 | 0.0025 | tr. | tr. |
| 6 | 0.0013 | 3.12 | 0.50 | 0.012 | 0.0004 | 1.21 | 0.0020 | 0.0002 | tr. | tr. |
| 7 | 0.0015 | 3.12 | 1.30 | 0.012 | 0.0004 | 1.21 | 0.0020 | 0.0002 | tr. | tr. |
| 8 | 0.0014 | 3.13 | 1.60 | 0.012 | 0.0004 | 1.21 | 0.0021 | 0.0002 | tr. | tr. |
| 9 | 0.0013 | 3.09 | 2.50 | 0.012 | 0.0004 | 1.21 | 0.0018 | 0.0002 | tr. | tr. |
| 10 | 0.0012 | 3.11 | 3.50 | 0.012 | 0.0004 | 1.21 | 0.0016 | 0.0002 | tr. | tr. |
| 11 | 0.0016 | 3.10 | 5.50 | 0.010 | 0.0004 | 1.00 | 0.0022 | 0.0002 | tr. | tr. |
| 12 | 0.0013 | 3.11 | 0.50 | 0.012 | 0.0004 | 1.21 | 0.0015 | 0.0025 | tr. | tr. |
| 13 | 0.0016 | 3.12 | 1.55 | 0.012 | 0.0004 | 1.21 | 0.0017 | 0.0005 | tr. | tr. |
| 14 | 0.0018 | 3.12 | 1.56 | 0.012 | 0.0004 | 1.21 | 0.0020 | 0.0005 | tr. | tr. |
| 15 | 0.0020 | 3.13 | 1.56 | 0.012 | 0.0004 | 1.21 | 0.0017 | 0.0005 | tr. | tr. |
| 16 | 0.0020 | 3.12 | 1.56 | 0.012 | 0.0004 | 1.21 | 0.0018 | 0.0005 | tr. | tr. |
| 17 | 0.0021 | 3.12 | 1.56 | 0.012 | 0.0004 | 1.21 | 0.0020 | 0.0005 | tr. | tr. |
| 18 | 0.0018 | 3.12 | 1.57 | 0.012 | 0.0004 | 1.21 | 0.0019 | 0.0005 | tr. | tr. |
| 19 | 0.0016 | 3.12 | 1.58 | 0.012 | 0.0004 | 1.21 | 0.0019 | 0.0005 | 0.0020 | tr. |
| 20 | 0.0022 | 3.15 | 1.60 | 0.012 | 0.0004 | 1.21 | 0.0019 | 0.0015 | 0.0030 | tr. |
| 21 | 0.0014 | 3.16 | 1.59 | 0.012 | 0.0004 | 1.21 | 0.0021 | 0.0015 | 0.0040 | tr. |
| 22 | 0.0015 | 3.11 | 1.59 | 0.012 | 0.0004 | 1.21 | 0.0021 | 0.0016 | 0.0090 | tr. |
| 23 | 0.0016 | 3.12 | 1.61 | 0.012 | 0.0004 | 1.21 | 0.0018 | 0.0030 | 0.0030 | tr. |
| 24 | 0.0015 | 3.12 | 1.61 | 0.012 | 0.0004 | 1.21 | 0.0016 | 0.0005 | tr. | 0.0010 |
| 25 | 0.0017 | 3.15 | 1.62 | 0.012 | 0.0004 | 1.21 | 0.0022 | 0.0015 | tr. | 0.0010 |
| 26 | 0.0019 | 3.12 | 1.65 | 0.012 | 0.0004 | 1.21 | 0.0018 | 0.0015 | tr. | 0.0040 |
| 27 | 0.0021 | 1.00 | 1.62 | 0.030 | 0.0004 | 2.50 | 0.0017 | 0.0005 | tr. | tr. |
| 28 | 0.0014 | 3.13 | 1.60 | 0.012 | 0.0004 | 1.21 | 0.0021 | 0.0002 | tr. | tr. |
| 29 | 0.0014 | 3.13 | 1.60 | 0.012 | 0.0004 | 1.21 | 0.0021 | 0.0002 | tr. | tr. |
| 30 | 0.0014 | 3.13 | 1.60 | 0.012 | 0.0004 | 1.21 | 0.0021 | 0.0002 | tr. | tr. |
| 31 | 0.0020 | 2.20 | 1.30 | 0.012 | 0.0004 | 2.00 | 0.0020 | 0.0005 | tr. | tr. |
| 32 | 0.0016 | 3.50 | 1.10 | 0.005 | 0.0004 | 1.00 | 0.0017 | 0.0005 | tr. | tr. |
| 33 | 0.0015 | 4.70 | 1.10 | 0.005 | 0.0004 | 0.30 | 0.0018 | 0.0005 | tr. | tr. |
| 34 | 0.0015 | 2.80 | 1.60 | 0.012 | 0.0004 | 1.30 | 0.0015 | 0.0005 | tr. | tr. |
| 35 | 0.0017 | 2.50 | 1.60 | 0.012 | 0.0004 | 2.50 | 0.0016 | 0.0005 | tr. | tr. |
| 36 | 0.0019 | 1.50 | 1.60 | 0.012 | 0.0004 | 3.50 | 0.0018 | 0.0005 | tr. | tr. |
| 37 | 0.0017 | 2.80 | 1.60 | 0.012 | 0.0015 | 1.30 | 0.0016 | 0.0005 | tr. | tr. |
| 38 | 0.0018 | 2.80 | 1.60 | 0.012 | 0.0060 | 1.30 | 0.0014 | 0.0005 | tr. | tr. |
| 39 | 0.0015 | 2.80 | 1.60 | 0.012 | 0.0005 | 1.30 | 0.0016 | 0.0005 | tr. | tr. |
| 40 | 0.0015 | 2.80 | 1.60 | 0.012 | 0.0004 | 1.30 | 0.0065 | 0.0005 | tr. | tr. |
| 41 | 0.0069 | 2.80 | 1.60 | 0.012 | 0.0004 | 1.30 | 0.0013 | 0.0005 | tr. | tr. |

| | | | | | | Magnetic | | |
|---|---|---|---|---|---|---|---|---|
| | | | | | | properties | | |
| | | | | | | Iron | Magnetic | |
| | | | | | Sheet | loss | flux | |
| | Chemical component (mass %) | | | | thickness | W_{10/400} | density | |
| No. | Sb | Sn | Mo | Ti | (mm) | (W/kg) | B₅₀ (T) | Remarks |
| 1 | tr. | tr. | 0.0010 | 0.0001 | 0.35 | 15.10 | 1.67 | Invention steel |
| 2 | tr. | tr. | 0.0010 | 0.0001 | 0.35 | 15.15 | 1.67 | Invention steel |
| 3 | tr. | tr. | 0.0010 | 0.0001 | 0.35 | 15.30 | 1.67 | Invention steel |
| 4 | tr. | tr. | 0.0010 | 0.0002 | 0.35 | 15.61 | 1.67 | Comparative steel |
| 5 | tr. | tr. | 0.0010 | 0.0002 | 0.35 | 16.11 | 1.67 | Comparative steel |
| 6 | tr. | tr. | 0.0010 | 0.0002 | 0.35 | 16.00 | 1.69 | Comparative steel |
| 7 | tr. | tr. | 0.0010 | 0.0002 | 0.35 | 15.41 | 1.68 | Invention steel |
| 8 | tr. | tr. | 0.0010 | 0.0002 | 0.35 | 15.26 | 1.68 | Invention steel |
| 9 | tr. | tr. | 0.0010 | 0.0002 | 0.35 | 15.06 | 1.66 | Invention steel |
| 10 | tr. | tr. | 0.0010 | 0.0002 | 0.35 | 14.92 | 1.65 | Invention steel |
| 11 | fr. | tr. | 0.0010 | 0.0002 | 0.35 | 15.55 | 1.60 | Comparative steel |
| 12 | tr. | fr. | 0.0010 | 0.0002 | 0.35 | 16.12 | 1.67 | Comparative steel |
| 13 | tr. | tr. | 0.0010 | 0.0002 | 0.35 | 15.25 | 1.67 | Invention steel |
| 14 | 0.0050 | tr. | 0.0010 | 0.0002 | 0.35 | 15.16 | 1.68 | Invention steel |
| 15 | 0.0180 | tr. | 0.0010 | 0.0002 | 0.35 | 15.15 | 1.69 | Invention steel |
| 16 | tr. | 0.0080 | 0.0010 | 0.0002 | 0.35 | 15.15 | 1.68 | Invention steel |
| 17 | tr. | 0.0120 | 0.0010 | 0.0002 | 0.35 | 15.10 | 1.69 | Invention steel |
| 18 | tr. | 0.0350 | 0.0010 | 0.0002 | 0.35 | 15.02 | 1.69 | Invention steel |
| 19 | tr. | tr. | 0.0010 | 0.0002 | 0.35 | 14.91 | 1.67 | Invention steel |
| 20 | tr. | tr. | 0.0010 | 0.0002 | 0.35 | 15.09 | 1.67 | Invention steel |
| 21 | tr. | tr. | 0.0010 | 0.0002 | 0.35 | 15.12 | 1.67 | Invention steel |
| 22 | tr. | tr. | 0.0010 | 0.0002 | 0.35 | 15.56 | 1.67 | Comparative steel |
| 23 | tr. | tr. | 0.0010 | 0.0002 | 0.35 | 15.63 | 1.67 | Comparative steel |
| 24 | tr. | tr. | 0.0010 | 0.0002 | 0.35 | 14.92 | 1.67 | Invention steel |
| 25 | tr. | tr. | 0.0010 | 0.0002 | 0.35 | 15.12 | 1.67 | Invention steel |
| 26 | tr. | tr. | 0.0010 | 0.0002 | 0.35 | 15.16 | 1.67 | Invention steel |
| 27 | tr. | tr. | 0.0010 | 0.0002 | 0.35 | 18.50 | 1.67 | Comparative steel |
| 28 | tr. | tr. | 0.0002 | 0.0002 | 0.35 | 15.35 | 1.68 | Invention steel |
| 29 | tr. | tr. | 0.0020 | 0.0002 | 0.35 | 15.26 | 1.68 | Invention steel |
| 30 | tr. | tr. | 0.0029 | 0.0002 | 0.35 | 15.41 | 1.68 | Invention steel |
| 31 | tr. | tr. | 0.0010 | 0.0002 | 0.35 | 15.10 | 1.67 | Invention steel |
| 32 | tr. | tr. | 0.0010 | 0.0002 | 0.35 | 14.82 | 1.67 | Invention steel |
| 33 | tr. | tr. | 0.0010 | 0.0002 | 0.35 | 14.51 | 1.60 | Comparative steel |
| 34 | tr. | tr. | 0.0010 | 0.0002 | 0.35 | 14.97 | 1.67 | Invention steel |
| 35 | tr. | tr. | 0.0010 | 0.0002 | 0.35 | 14.72 | 1.67 | Invention steel |
| 36 | tr. | tr. | 0.0010 | 0.0002 | 0.35 | 14.98 | 1.62 | Comparative steel |
| 37 | tr. | tr. | 0.0010 | 0.0002 | 0.35 | 15.20 | 1.65 | Invention steel |
| 38 | tr. | tr. | 0.0010 | 0.0002 | 0.35 | 17.30 | 1.65 | Comparative steel |
| 39 | tr. | tr. | 0.0010 | 0.0035 | 0.35 | 16.30 | 1.66 | Comparative steel |
| 40 | tr. | tr. | 0.0010 | 0.0002 | 0.35 | 16.60 | 1.65 | Comparative steel |
| 41 | tr. | tr. | 0.0010 | 0.0002 | 0.35 | 16.40 | 1.66 | Comparative steel |

As seen from Table 1, the steel sheets satisfying our chemical composition, particularly steel sheets having a reduced Pb content are excellent in high-frequency iron loss property irrespective of a high Mn content.

### INDUSTRIAL APPLICABILITY

Our steel sheets can also be applied to a motor for working machine, a motor for hybrid EV, a high-speed generator and so on.

1.-5. (canceled)

6. A non-oriented electrical steel sheet having a chemical composition comprising C: not more than 0.005 mass %, Si: 1.5-4 mass %, Mn: 1-5 mass %, P: not more than 0.1 mass %, S: not more than 0.005 mass %, Al: not more than 3 mass %, N: not more than 0.005 mass %, Pb: not more than 0.0010 mass % and the remainder being Fe and inevitable impurities.

7. The non-oriented electrical steel sheet according to claim 6, further comprising one or two of Ca: 0.0005-0.007 mass % and Mg: 0.0002-0.005 mass % in addition to the above chemical composition.

8. The non-oriented electrical steel sheet according to claim 6, further comprising one or two of Sb: 0.0005-0.05 mass % and Sn: 0.0005-0.05 mass % in addition to the above chemical composition.

9. The non-oriented electrical steel sheet according to claim 7, further comprising one or two of Sb: 0.0005-0.05 mass % and Sn: 0.0005-0.05 mass % in addition to the above chemical composition.

10. The non-oriented electrical steel sheet according to claim 6, further comprising Mo: 0.0005-0.0030 mass % in addition to the above chemical composition.

11. The non-oriented electrical steel sheet according to claim 7, further comprising Mo: 0.0005-0.0030 mass % in addition to the above chemical composition.

12. The non-oriented electrical steel sheet according to claim 8, further comprising Mo: 0.0005-0.0030 mass % in addition to the above chemical composition.

13. The non-oriented electrical steel sheet according to claim 9, further comprising Mo: 0.0005-0.0030 mass % in addition to the above chemical composition.

14. The non-oriented electrical steel sheet according to claim 6, further comprising Ti: not more than 0.002 mass %.

15. The non-oriented electrical steel sheet according to claim 7, further comprising Ti: not more than 0.002 mass %.

16. The non-oriented electrical steel sheet according to claim 8, further comprising Ti: not more than 0.002 mass %.

17. The non-oriented electrical steel sheet according to claim 9, further comprising Ti: not more than 0.002 mass %.

18. The non-oriented electrical steel sheet according to claim 10, further comprising Ti: not more than 0.002 mass %.

19. The non-oriented electrical steel sheet according to claim 11, further comprising Ti: not more than 0.002 mass %.

20. The non-oriented electrical steel sheet according to claim 12, further comprising Ti: not more than 0.002 mass %.

21. The non-oriented electrical steel sheet according to claim 13, further comprising Ti: not more than 0.002 mass %.
